(19) United States
(12) Patent Application Publication
(10) Pub. No.: US 2007/0221666 A1
(43) Pub. Date: Sep. 27, 2007

(54) Susceptor with apertured support

(76) Inventors: Daniel J. Keefe, Cincinnati, OH (US); Laurence M.C. Lai, Mississauga (CA)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/714,489

(22) Filed: Mar. 6, 2007

Related U.S. Application Data
(60) Provisional application No. 60/780,699, filed on Mar. 9, 2006.

(51) Int. Cl. H05B 6/80

(52) U.S. Cl. 219/728

(57) ABSTRACT

A construct for heating, browning, and/or crisping a food item in a microwave oven includes a microwave energy interactive element at least partially joined to a dimensionally-stable support and at least one an aperture extending through the microwave energy interactive element and support. The aperture has an elongated shape with a widened central portion that facilitates manufacture of the construct.

### CROSS-REFERENCE TO RELATED APPLICATION

This application claims the benefit of U.S. Provisional Application No. 60/780,699, filed Mar. 9, 2006, which is incorporated by reference herein in its entirety.

### TECHNICAL FIELD

The present invention relates to materials, packages, constructs, and systems for heating, browning, and/or crisping a food item in a microwave oven.

### BACKGROUND

Microwave ovens provide a convenient means for heating a variety of food items, including sandwiches and other bread and/or dough-based products such as pizzas and pies. However, microwave ovens tend to cook such items unevenly and are unable to achieve the desired balance of thorough heating and a browned, crisp crust. As such, there is a continuing need for improved materials, packages, and other constructs that provide the desired degree of heating, browning, and/or crisping of various food items in a microwave oven. Additionally, there is a need for such constructs to be manufactured in a manner that minimizes waste and/or damage to the construct.

### SUMMARY

The present invention is directed generally to various constructs that improve the heating, browning, and/or crisping of a food item in a microwave oven. The various constructs of the present invention generally include a microwave energy interactive element overlying at least a portion of a rigid or semi-rigid support. Each microwave interactive element comprises one or more microwave energy interactive components or segments arranged in a particular configuration to absorb microwave energy, transmit microwave energy, reflect microwave energy, or direct microwave energy, as needed or desired for a particular microwave heating construct and food item.

The support may be selected to provide thermal insulation between the microwave energy interactive element and the heating environment. In one example, the support comprises a corrugated paper or paperboard.

If needed or desired, at least one aperture or cutout may extend through the microwave energy interactive element and the support to provide ventilation to the bottom surface of the food item. The shape of the aperture may be selected to enhance the manufacturing of the construct. In one example, the aperture is somewhat elongated with a widened central portion along the length thereof.

According to one aspect of the invention, a construct for heating, browning, and/or crisping a food item in a microwave oven comprises a microwave energy interactive element at least partially joined to a dimensionally-stable support and an aperture extending through the microwave energy interactive element and support. The aperture has an elongated shape with a widened central portion. The aperture may generally resemble an elongated diamond shape with rounded ends, an obround shape with a rounded central portion, or any other suitable shape.

In one variation, the aperture includes a length, a center width substantially centrally disposed along the length, and an end width. The length is from about 20 to about 70 mm, the center width is from about 5 to about 20 mm, and the end width is from about 2 to about 8 mm.

In another variation, the aperture is a first aperture of a plurality of apertures, and at least two of the plurality of apertures have substantially the same shape and dimensions. In yet another variation, the aperture is a first aperture of a plurality of apertures, and at least two of the plurality of apertures differ in shape or dimensions.

In still another variation, the construct has a longitudinal centerline extending in a longitudinal direction and a transverse centerline extending in a transverse direction, the aperture is a first aperture of a plurality of apertures, and the apertures are arranged in a substantially symmetrical configuration along at least one of the longitudinal centerline and transverse centerline.

The invention also encompasses a method of making the construct. The method comprises joining the microwave energy interactive element, for example, a susceptor film, to the dimensionally-stable support, for example, a corrugated material, cutting the microwave energy interactive element and support to define the aperture and a removable chad, and removing the chad from the construct with a stripping pin.

According to another aspect of the invention, a microwave energy interactive construct comprises a susceptor film overlying and at least partially joined to a corrugated support and a plurality of elongated apertures extending through the susceptor film and corrugated support. Each aperture has a widened portion substantially centered along a length of the aperture.

In one variation, each aperture generally resembles an elongated diamond shape with rounded ends, each aperture includes an end width, the length of each aperture is from about 20 to about 70 mm, the widened portion of each aperture is from about 5 to about 20 mm in width, and the end width of each aperture is from about 2 to about 8 mm.

In another variation, each aperture is generally obround with a rounded central portion, each aperture includes an end width, the length of each aperture is from about 20 to about 70 mm, the widened portion of each aperture is from about 5 to about 20 mm in width, and the end width of each aperture is from about 2 to about 8 mm.

According to yet another aspect of the invention, a construct for heating, browning, and/or crisping a food item in a microwave oven comprises a microwave energy interactive material supported on a polymer film, a corrugated support joined to the microwave energy interactive material, and a plurality of apertures extending through the microwave energy interactive material, polymer film, and corrugated support. Each aperture has a length, a center width, and an end width, the length of each aperture is from about 20 to about 70 mm, the center width of each aperture is from about 5 to about 20 mm, and the end width of each aperture is from about 2 to about 8 mm. In one variation, at least one aperture has a length of from about 45 to about 65 mm, at least one aperture has a length of from about 30 to about 55 mm, and at least one aperture has a length of from about 20 to about 40 mm. In one example, the construct may be made by cutting the microwave energy interactive material, polymer film, and corrugated support to define each of the plurality of apertures and a plurality of removable chads, and removing the chads with a plurality of stripping pins to form the construct.

Various other aspects, features, and advantages of the present invention will become apparent from the following description and accompanying figures.

### BRIEF DESCRIPTION OF THE DRAWINGS

The description refers to the accompanying drawings in which like reference characters refer to like parts throughout the several views, and in which:

FIG. 1A is a schematic plan view of an exemplary microwave energy interactive construct according to various aspects of the present invention;

FIG. 1B is a schematic cross-sectional view of the construct of FIG. 1A, taken along a line 1B-1B;

FIG. 2A is a schematic plan view of another exemplary microwave energy interactive construct according to various aspects of the present invention; and

FIG. 2B is a schematic cross-sectional view of the construct of FIG. 2A, taken along a line 2B-2B.

### DESCRIPTION

The present invention relates generally to various materials, trays, packages, and systems (collectively “constructs”) for heating a food item in a microwave oven, and methods of making such constructs. Although several different aspects, implementations, and embodiments of the various inventions are provided, numerous interrelationships between, combinations thereof, and modifications of the various inventions, aspects, implementations, and embodiments of the invention are contemplated hereby.

Various aspects of the invention may be illustrated by referring to the figures. For simplicity, like numerals may be used to describe like features. It will be understood that where a plurality of similar features are depicted, not all of such features necessarily are labeled on each figure. While various exemplary embodiments are shown and described in detail herein, it also will be understood that any of the features may be used in any combination, and that such combinations are contemplated hereby.

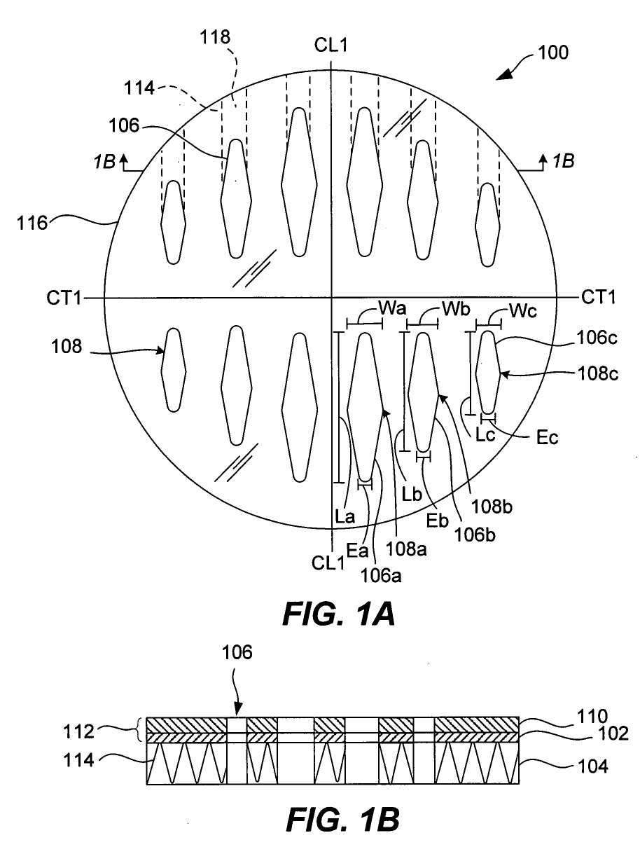

FIGS. 1A and 1B depict an exemplary microwave energy interactive construct 100 according to various aspects of the invention. The construct 100 is substantially circular in shape, and may be suitable for heating, for example, a pizza, panini, or other circular food item thereon. However, numerous other shapes are contemplated hereby, for example, square, rectangular, triangular, or any other regular or irregular shape. The construct 100 includes a microwave energy interactive element 102 at least partially overlying a support 104. The construct 100 includes a plurality of cutouts or apertures 106 (only some of which are labeled) that extend through the microwave energy interactive element 102 and the support 104, although it is contemplated that the apertures may extend through fewer layers if desired. In this example, the apertures 106 are elongated with a widened central portion 108, generally resembling an elongated diamond shape having rounded ends. However, any suitable shape or combination of shapes may be used. In this example, the apertures 106 vary in dimensions, but may have uniform dimensions if desired. The arrangement of apertures 106 is substantially symmetrical along a transverse centerline or axis CT1 and a longitudinal centerline or axis CL1. However, other configurations are contemplated hereby.

In the example illustrated in FIGS. 1A and 1B, the microwave energy interactive element 102 comprises a thin layer of microwave interactive material that tends to absorb microwave energy, thereby generating heat at the interface with a food item (not shown). Such an element may be referred to as a “susceptor”. However, in this and other aspects of the invention, other microwave energy interactive elements are contemplated.

In this and other aspects of the invention, the microwave energy interactive material may be an electroconductive or semiconductive material, for example, a metal or a metal alloy provided as a metal foil; a vacuum deposited metal or metal alloy; or a metallic ink, an organic ink, an inorganic ink, a metallic paste, an organic paste, an inorganic paste, or any combination thereof. Examples of metals and metal alloys that may be suitable for use with the present invention include, but are not limited to, aluminum, chromium, copper, inconel alloys (nickel-chromium-molybdenum alloy with niobium), iron, magnesium, nickel, stainless steel, tin, titanium, tungsten, and any combination or alloy thereof.

Alternatively, the microwave energy interactive material may comprise a metal oxide. Examples of metal oxides that may be suitable for use with the present invention include, but are not limited to, oxides of aluminum, iron, and tin, used in conjunction with an electrically conductive material where needed. Another example of a metal oxide that may be suitable for use with the present invention is indium tin oxide (ITO). ITO can be used as a microwave energy interactive material to provide a heating effect, a shielding effect, a browning and/or crisping effect, or a combination thereof. For example, to form a susceptor, ITO may be sputtered onto a clear polymer film. The sputtering process typically occurs at a lower temperature than the evaporative deposition process used for metal deposition. ITO has a more uniform crystal structure and, therefore, is clear at most coating thicknesses. Additionally, ITO can be used for either heating or field management effects. ITO also may have fewer defects than metals, thereby making thick coatings of ITO more suitable for field management than thick coatings of metals, such as aluminum.

Alternatively still, the microwave energy interactive material may comprise a suitable electroconductive, semiconductive, or non-conductive artificial dielectric or ferroelectric. Artificial dielectrics comprise conductive, subdivided material in a polymeric or other suitable matrix or binder, and may include flakes of an electroconductive metal, for example, aluminum.

While susceptors are described in detail herein in the illustrated exemplary constructs, the microwave interactive element alternatively or additionally may comprise a foil having a thickness sufficient to shield one or more selected portions of the food item from microwave energy. Such “shielding elements” may be used where the food item is prone to scorching or drying out during heating.

The shielding element may be formed from various materials and may have various configurations, depending on the particular application for which the shielding element is used. Typically, the shielding element is formed from a conductive, reflective metal or metal alloy, for example, aluminum, copper, or stainless steel. The shielding element generally may have a thickness of from about 0.000285 inches to about 0.05 inches. In one aspect, the shielding element has a thickness of from about 0.0003 inches to about 0.03 inches. In another aspect, the shielding element has a thickness of from about 0.00035 inches to about 0.020 inches, for example, 0.016 inches.

As still another example, the microwave interactive element may comprise a segmented foil, such as, but not limited to, those described in U.S. Pat. Nos. 6,204,492, 6,433,322, 6,552,315, and 6,677,563, each of which is incorporated by reference in its entirety. Although segmented foils are not continuous, appropriately spaced groupings of such segments may act as a shielding element. Such foils also may be used in combination with susceptor elements and, depending on the configuration and positioning of the segmented foil, the segmented foil may operate to promote heating rather than to shield microwave energy.

Any of the numerous microwave interactive elements described herein or contemplated hereby may be continuous, that is, without substantial breaks or interruptions, or may be discontinuous, for example, by including one or more breaks or apertures that transmit microwave energy therethrough. The breaks or apertures may be sized and positioned to heat particular areas of the food item selectively. The number, shape, size, and positioning of such breaks or apertures may vary for a particular application depending on type of construct being formed, the food item to be heated therein or thereon, the desired degree of shielding, browning, and/or crisping, whether direct exposure to microwave energy is needed or desired to attain uniform heating of the food item, the need for regulating the change in temperature of the food item through direct heating, and whether and to what extent there is a need for venting.

It will be understood that the aperture may be a physical aperture or void in the material used to form the construct, as is shown in FIGS. 1A and 1B, or may be a non-physical “aperture” (not shown). A non-physical aperture may be a portion of the construct formed without a microwave energy interactive material, or a portion of the construct from which the microwave energy interactive material has been removed, or a portion of the construct where the microwave energy interactive material has been chemically or mechanically deactivated. While both physical and non-physical apertures allow the food item to be heated directly by the microwave energy, a physical aperture also provides a venting function to allow steam or other vapors to escape from the interior of the construct.

Still viewing FIGS. 1A and 1B, the microwave energy interactive material 102 may overlie and/or be supported on at least a portion of a microwave energy transparent substrate 110 for ease of handling and/or to prevent contact between the microwave interactive material and the food item. Apertures 106 extend through the substrate 110 and therefore may be referred to as “venting apertures”.

In this example, the substrate 110 comprises a polymer film, thereby collectively forming susceptor film 112. As used herein the term “polymer” or “polymeric material” includes, but is not limited to, homopolymers, copolymers, such as for example, block, graft, random, and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic, and random symmetries.

Examples of polymer films that may be suitable include, but are not limited to, polyolefins, polyesters, polyamides, polyimides, polysulfones, polyether ketones, cellophanes, or any combination thereof. Other non-conducting substrate materials such as paper and paper laminates, metal oxides, silicates, cellulosics, or any combination thereof, also may be used.

In one particular example, the polymer film comprises polyethylene terephthalate. Examples of polyethylene terephthalate films that may be suitable for use as the substrate include, but are not limited to, MELINEX®, commercially available from DuPont Teijan Films (Hopewell, Va.), and SKYROL, commercially available from SKC, Inc. (Covington, Ga.). Polyethylene terephthalate films are used in commercially available susceptors, for example, the QWlKWAVE® Focus susceptor and the MICRORITE® susceptor, both available from Graphic Packaging International (Marietta, Ga.).

The thickness of the film generally may be from about 35 gauge to about 10 mil. In one aspect, the thickness of the film is from about 40 to about 80 gauge. In another aspect, the thickness of the film is from about 45 to about 50 gauge. In still another aspect, the thickness of the film is about 48 gauge.

The microwave energy interactive material may be applied to the substrate in any suitable manner, and in some instances, the microwave energy interactive material is printed on, extruded onto, sputtered onto, evaporated on, or laminated to the substrate. The microwave energy interactive material may be applied to the substrate in any pattern, and using any technique, to achieve the desired heating effect of the food item.

For example, the microwave energy interactive material may be provided as a continuous or discontinuous layer or coating including circles, loops, hexagons, islands, squares, rectangles, octagons, and so forth. Examples of various patterns and methods that may be suitable for use with the present invention are provided in U.S. Pat. Nos. 6,765,182; 6,717,121; 6,677,563; 6,552,315; 6,455,827; 6,433,322; 6,414,290; 6,251,451; 6,204,492; 6,150,646; 6,114,679; 5,800,724; 5,759,422; 5,672,407; 5,628,921; 5,519,195; 5,424,517; 5,410,135; 5,354,973; 5,340,436; 5,266,386; 5,260,537; 5221,419; 5,213,902; 5,117,078; 5,039,364; 4,963,424; 4,936,935; 4,890,439; 4,775,771; 4,865,921; and Re. 34,683, each of which is incorporated by reference herein in its entirety. Although particular examples of patterns of microwave energy interactive material are shown and described herein, it should be understood that other patterns of microwave energy interactive material are contemplated by the present invention.

Still viewing FIGS. 1A and 1B, the microwave energy interactive element 102 overlies and may be joined to at least a portion of a microwave energy transparent, dimensionally-stable support 104, as stated above.

Various materials may be used to form the support. In one example, all or a portion of the support may be formed at least partially from a paper or paperboard material. In one aspect, the support is formed from paper generally having a basis weight of from about 15 to about 60 lbs/ream, for example, from about 20 to about 40 lbs/ream. In one particular example, the paper has a basis weight of about 25 lbs/ream. In another aspect, the support is formed from paperboard having a basis weight of from about 60 to about 330 lbs/ream, for example, from about 80 to about 140 lbs/ream. The paperboard generally may have a thickness of from about 6 to about 30 mils, for example, from about 12 to about 28 mils. In one particular example, the paperboard has a thickness of about 12 mils. Any suitable paperboard may be used, for example, a solid bleached or solid unbleached sulfate board, such as SUS® board, commercially available from Graphic Packaging International. If needed or desired, one or more portions of the support may be laminated to or coated with one or more different or similar sheet-like materials at selected panels or panel sections.

In another aspect, the support 104 is at least partially formed from a corrugated material, commonly formed from one or more virgin and/or recycled cellulosic materials and/or polymers, as is illustrated in FIGS. 1A and 1B. Some corrugated materials comprise a flat side and a corrugated side. Such materials often are referred to as “single faced”. Single faced corrugated materials that may be suitable for use with the present invention include, but are not limited to, flute sizes A, B (47 flutes/linear ft), and E (90 flutes/linear ft). Other corrugated materials comprise a first flat side, a second flat side, and corrugated material therebetween. Such materials often are referred to as “double faced”. Double faced corrugated materials that may be suitable for use with the present invention include, but are not limited to, flute sizes B, C, E, and F. The present invention contemplates any configuration of these materials in the construct. Thus, for example, the microwave energy interactive element may overlie a flat side or a fluted side of a corrugated material.

Corrugated materials generally have a longitudinal direction that runs along the length of the flutes, and a transverse direction that runs across the flutes. Where the support 104 is or otherwise includes a corrugated material, the flutes or corrugations 114 of the material may define passageways that extend to the peripheral edge 116 of the construct 100. Although such passageways are hidden from view in FIG. 1A, portions of some of the passageways 118 are schematically illustrated by broken lines in FIG. 1A as extending from respective ones of the apertures 106 to the peripheral edge 116 of the construct 100. As schematically illustrated in FIG. 1A for representative ones of the apertures 106 and corrugation passageways 118, the apertures 106 are typically respectively open to the corrugation passageways 118, so that the apertures 106 in combination with the respective corrugation passageways 118 define venting channels or passageways that are open at the peripheral edge 116 of the construct 100. In this example, the apertures 106 are shown as being in substantially parallel alignment with the direction of the flutes. However, it will be understood that one or more apertures may extend in other directions that may be oblique or perpendicular with respect to the direction of the flutes.

Corrugated materials may be relatively stiff when the material is flexed in the longitudinal direction, and relatively flexible when flexed in the transverse direction. Thus, it is contemplated that structural elements may be added to enhance the rigidity of the construct. Conversely, it also is contemplated that the construct may include elements that weaken the structure, for example, a score line, if needed or desired for a particular application.

As another example, the support may be formed at least partially from a polymer or polymeric material. One polymer that may be suitable for use with the present invention is polycarbonate. Other examples of other polymers that may be suitable for use with the present invention include, but are not limited to, polyolefins, e.g. polyethylene, polypropylene, polybutylene, and copolymers thereof, polytetrafluoroethylene; polyesters, e.g. polyethylene terephthalate, e.g., coextruded polyethylene terephthalate; vinyl polymers, e.g., polyvinyl chloride, polyvinyl alcohol, ethylene vinyl alcohol, polyvinylidene chloride, polyvinyl acetate, polyvinyl chloride acetate, polyvinyl butyral; acrylic resins, e.g. polyacrylate, polymethylacrylate, and polymethylmethacrylate; polyamides, e.g., nylon 6,6; polystyrenes; polyurethanes; cellulosic resins, e.g., cellulosic nitrate, cellulosic acetate, cellulosic acetate butyrate, ethyl cellulose; copolymers of any of the above materials; or any blend or combination thereof.

The various constructs of the invention, for example, construct 100, may be formed according to numerous processes known to those in the art. In one example, a microwave interactive web, for example, a susceptor film, is joined at least partially to the support using adhesive bonding, thermal bonding, ultrasonic bonding, mechanical stitching, or any other suitable process. Either or both of the support and microwave energy interactive web may be provided as a sheet of material, a roll of material, or a die cut material in the shape of the construct to be formed.

The resulting structure then may be cut to form the one or more apertures. Any suitable process for forming the aperture may be used, for example, die cutting or laser cutting. Such processes typically result in the formation of a chad that may be removed, for example, using one or more stripping pins. When the chad is removed, care must be taken not to damage the construct, particularly the layer of microwave energy interactive material. If the construct is damaged, the ability of the construct to heat, brown, and/or crisp a food item may be affected adversely. It has been found that the ability to remove the chad efficiently without-damaging the construct may depend on the shape of the aperture being formed. More particularly, it has been found that there may be one or more aperture shapes and/or dimensions that facilitate removal of the chad therefrom.

As stated above, the apertures of the invention are generally elongate in shape with a widened portion located substantially centrally along the length of the aperture. Each aperture can be characterized by a length L, a centrally measured width W, and an end width E. For example, in the construct 100 illustrated in FIGS. 1A and 1B, apertures 106a, 106b, and 106c, each have a widened central portion 108a, 108b, and 108c, such that each aperture can be characterized by a respective length, La, Lb, and Lc, width Wa, Wb, and We (measured approximately centered along the length L), and end width Ea, Eb, and Ec. The various lengths, widths, and ratios of each thereof are selected to facilitate removal of the chad using a stripping pin without significantly damaging the construct.

In each of various examples, the apertures may each have an overall length L or major dimension of from about 10 to about 100 mm, from about 20 to about 70 mm, from about 30 to about 55 mm, from about 20 to about 40 mm, from about 35 to about 55 mm, from about 45 to about 65 mm, about 30 mm, about 47 mm, or about 55 mm.

Additionally, in each of various examples, the apertures may each have a width W at the widest point of from about 2 mm to about 30 mm, from about 5 to about 20 mm, from about 5 to about 15 mm, from about 7 to about 12 mm, about 10 mm, at least about 2 mm, at least about 3 mm, at least about 4 mm, at least about 5 mm, at least about 6 mm, at least about 7 mm, at least about 8 mm, at least about 9 mm, at least about 10 mm, at least about 15 mm, at least about 20 mm, or at least about 25 mm.

Additionally, in each of various examples, the apertures may each have an end width E of from about 0.5 mm to about 10 mm, from about 1 to about 9 mm, from about 2 to about 8 mm, from about 3 to about 7 mm, from about 4 to about 6 mm, about 1 mm, about 2 mm, about 3 mm, about 4 mm, about 5 mm, about 6 mm, about 7 mm, about 8 mm, about 9 mm, about 10 mm, at least about 0.5 mm, at least about 1 mm, at least about 2 mm, at least about 3 mm, at least about 4 mm, at least about 5 mm, at least about 5 mm, at least about 6 mm, at least about 7 mm, at least about 8 mm, at least about 9 mm, or at least about 10 mm.

Further, in each of various examples, the apertures may each have a length L to width W ratio R of from about 1:1 to about 10:1, from about 2:1 to about 8:1, from about 3:1 to about 7:1, from about 4:1 to about 6:1, about 1:1, about 1.5:1, about 2:1, about 2.5:1, about 3:1, about 3.5:1, about 4:1, about 4.5:1, about 5:1, about 5.5:1, about 6:1, about 6.5:1, about 7:1, about 7.5:1, about 8:1, about 8.5:1, about 9:1, about 9.5:1, about 10:1, up to about 1:1, up to about 2:1, up to about 3:1, up to about 4:1, up to about 5:1, up to about 6:1, up to about 7:1, up to about 8:1, up to about 9:1, or up to about 10:1.

In one particular example, the construct 100 has an overall diameter of from about 150 to about 175 mm, at least one aperture 106a has a length La of from about 45 to about 65 mm, width Wa of from about 5 to about 15 mm, and end width Ea of from about 3 to about 7 mm, at least one aperture 106b has a length Lb of from about 30 to about 55 mm, width Wb of from about 5 to about 15 mm, and end width Eb of from about 3 to about 7 mm, and at least one aperture 106c has a length Lc of from about 20 to about 40 mm, width Wc of from about 5 to about 15 mm, and end width Ec of from about 3 to about 7 mm.

In another particular example, the construct has an overall diameter of about 165 mm, La is about 55 mm, Lb is about 47 mm, Lc is about 30 mm, Wa is about 10 mm, Wb is about 10 mm, Wc is about 10 mm, Ea is about 5 mm, Eb is about 5 mm, and Ec is about 5 mm.

To use the construct, a food item (not shown) is placed on the construct 100, typically on the substrate 110, and placed into a microwave oven (not shown). When the construct is exposed to microwave energy, the susceptor converts the microwave energy to thermal energy, which then heats the adjacent food item. As a result, the heating, browning, and/or crisping of the food item may be enhanced. The air and other gases between the flutes of the corrugated support 104 provide insulation between the food item and the ambient environment of the microwave oven, thereby increasing the amount of sensible heat that stays within or is transferred to the food item. At the same time, apertures 106 allow any moisture to be vented away from the food item to enhance crisping of the food item while allowing microwave energy to pass therethrough to heat the food item directly.

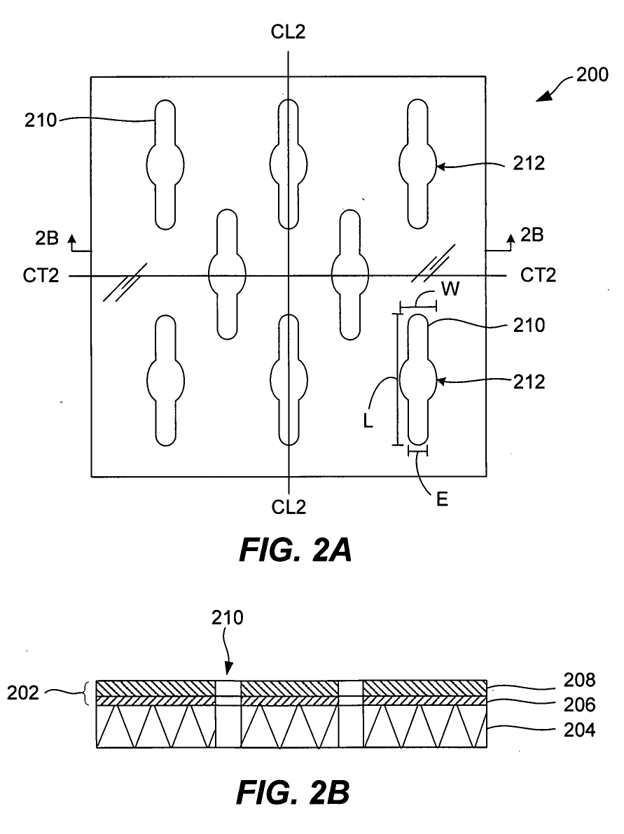

FIGS. 2A and 2B depict another exemplary microwave energy interactive construct 200 according to various aspects of the invention. The construct 200 is similar to construct 100, except for variations noted and variations that will be apparent to those of skill in the art.

As illustrated in FIG. 2, the construct 200 is substantially square in shape, and may be suitable for heating, for example, a square pizza, panini, or other square shaped food item thereon. However, numerous other shapes are contemplated hereby, for example, circular, rectangular, triangular, or any other regular or irregular shape. The construct 200 includes a susceptor film 202 overlying and at least partially joined to a support 204. The susceptor film 202 comprises a microwave energy interactive element 206 supported on a substrate 208. A plurality of cutouts or apertures 210 (only two of which are labeled) extend through the susceptor film 202 and support 204. The arrangement of apertures 210 is substantially symmetrical along a transverse centerline or axis CT2 and a longitudinal centerline or axis CL2. Further, each aperture 208 is approximately equal in dimension. However, other dimensions and configurations of various apertures are contemplated hereby.

In this example, the apertures 208 are elongated with a widened central portion 212 having a substantially round shape, generally resembling a circle or an ellipse centered along the length of an obround shape. As used herein, the term “obround” refers to a shape having two parallel edges bounded by curved ends, generally resembling a racetrack. However, any suitable shape or combination of shapes may be used.

The exemplary construct 200 may be formed and used in a manner similar to that described in connection with the construct 100 shown in FIGS. 1A and 1B.

In accordance with the invention, the various apertures 210 may be dimensioned to facilitate removal of a chad therefrom without damaging the construct 200, particularly the layer of microwave energy interactive material 206. The various apertures each may have a length L, a centrally measured width W, and end width E, and various ratios thereof. The various dimensions may be the same as those described above, or may be any other suitable dimension.

Thus, in one particular example, the construct 200 has an overall longitudinal dimension of from about 150 to about 175 mm, an overall transverse dimension of from about 150 to about 175 mm, and at least one aperture 210 having length L of from about 45 to about 65 mm, width W of from about 5 to about 15 mm, and end width E of from about 3 to about 7 mm. In another particular example, the construct 200 has an overall longitudinal dimension of about 165 mm, an overall transverse dimension of about 165 mm, and at least one aperture 210 having a length L of 55 mm, width W of about 10 mm, and end width E of about 5 mm.

While particular examples are described herein, it will be understood that numerous other constructs are contemplated by the present invention. For example, numerous materials may be suitable for use in forming the construct of the invention, provided that the materials are resistant to softening, scorching, combusting, or degrading at typical microwave oven heating temperatures, for example, at about 250° F.

Optionally, one or more panels of the various constructs described herein or contemplated hereby may be coated with varnish, clay, or other materials, either alone or in combination. The coating may then be printed over with product advertising or other information or images. The constructs also may be coated to protect any information printed thereon. Furthermore, the constructs may be coated with, for example, a moisture barrier layer, on either or both sides.

Alternatively or additionally, any of the constructs of the present invention may be coated or laminated with other materials to impart other properties, such as absorbency, repellency, opacity, color, printability, stiffness, or cushioning. For example, absorbent susceptors are described in U.S. Provisional Application No. 60/604,637, filed Aug. 25, 2004, and U.S. patent application Ser. No. 11/211,858, to Middleton, et al., titled “Absorbent Microwave Interactive Packaging”, filed Aug. 25, 2005, both of which are incorporated herein by reference in their entirety. Additionally, the constructs may include graphics or indicia printed thereon.

Although certain embodiments of this invention have been described with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are used only for identification purposes to aid the reader's understanding of the various embodiments of the present invention, and do not create limitations, particularly as to the position, orientation, or use of the invention unless specifically set forth in the claims. Joinder references (e.g., joined, attached, coupled, connected, and the like) are to be construed broadly and may include intermediate members between a connection of elements and relative movement between elements. As such, joinder references do not necessarily imply that two elements are connected directly and in fixed relation to each other.

It will be recognized by those skilled in the art, that various elements discussed with reference to the various embodiments may be interchanged to create entirely new embodiments coming within the scope of the present invention. It is intended that all matter contained in the above description or shown in the accompanying drawings shall be interpreted as illustrative only and not limiting. Changes in detail or structure may be made without departing from the spirit of the invention. The detailed description set forth herein is not intended nor is to be construed to limit the present invention or otherwise to exclude any such other embodiments, adaptations, variations, modifications, and equivalent arrangements of the present invention.

Accordingly, it will be readily understood by those persons skilled in the art that, in view of the above detailed description of the invention, the present invention is susceptible of broad utility and application. Many adaptations of the present invention other than those herein described, as well as many variations, modifications, and equivalent arrangements will be apparent from or reasonably suggested by the present invention and the above detailed description thereof, without departing from the substance or scope of the present invention.

While the present invention is described herein in detail in relation to specific aspects, it is to be understood that this detailed description is only illustrative and exemplary of the present invention and is made merely for purposes of providing a full and enabling disclosure of the present invention. The detailed description set forth herein is not intended nor is to be construed to limit the present invention or otherwise to exclude any such other embodiments, adaptations, variations, modifications, and equivalent arrangements of the present invention.

What is claimed is:

1. A construct for heating, browning, and/or crisping a food item in a microwave oven, comprising:
a microwave energy interactive element at least partially joined to a dimensionally-stable support; and
an aperture extending through the microwave energy interactive element and support, the aperture having an elongated shape with a widened central portion.

2. The construct of claim 1, wherein the aperture generally resembles an elongated diamond shape with rounded ends.

3. The construct of claim 1, wherein the aperture generally resembles an obround shape with a rounded central portion.

4. The construct of claim 1, wherein
the aperture includes a length, a center width substantially centrally disposed along the length, and an end width,
the length is from about 20 to about 70 mm,
the center width is from about 5 to about 20 mm, and
the end width is from about 2 to about 8 mm.

5. The construct of claim 1, wherein the microwave energy interactive element comprises a layer of microwave energy interactive material.

6. The construct of claim 1, wherein the microwave energy interactive element comprises a susceptor.

7. The construct of claim 1, wherein
the microwave energy interactive element comprises a microwave energy interactive material, and
a polymer film overlies the microwave energy interactive material.

8. The construct of claim 1, wherein the support comprises a single faced corrugated material.

9. The construct of claim 1, wherein the support comprises a double faced corrugated material.

10. The construct of claim 1, wherein
the aperture is a first aperture of a plurality of apertures, and
at least two of the plurality of apertures have substantially the same shape and dimensions.

11. The construct of claim 1, wherein
the aperture is a first aperture of a plurality of apertures, and
at least two of the plurality of apertures differ in shape, dimensions, or any combination.

12. The construct of claim 1 having a longitudinal centerline extending in a longitudinal direction and a transverse centerline extending in a transverse direction, wherein
the aperture is a first aperture of a plurality of apertures, and
the apertures are arranged in a substantially symmetrical configuration with respect to at least one of the longitudinal centerline and transverse centerline.

13. A method of making the construct of claim 1, comprising:
joining the microwave energy interactive element to the dimensionally-stable support;
cutting the microwave energy interactive element and support to define the aperture and a removable chad; and
removing the chad from the construct with a stripping pin.

14. A microwave energy interactive construct comprising:
a susceptor film overlying and at least partially joined to a corrugated support; and
a plurality of elongated apertures extending through the susceptor film and corrugated support, wherein each aperture has a widened portion substantially centered along a length of the aperture.

15. The construct of claim 14, wherein
each aperture generally resembles an elongated diamond shape with rounded ends,
each aperture includes an end width,
the length of each aperture is from about 20 to about 70 mm,
the widened portion of each aperture is from about 5 to about 20 mm in width, and
the end width of each aperture is from about 2 to about 8 mm.

16. The construct of claim 14, wherein
each aperture generally resembles an obround shape with a rounded central portion,
each aperture includes an end width,
the length of each aperture is from about 20 to about 70 mm,
the widened portion of each aperture is from about 5 to about 20 mm in width, and
the end width of each aperture is from about 2 to about 8 mm.

17. A method of making the construct of claim 14, comprising:
joining the susceptor film to the corrugated support;
cutting the susceptor film and corrugated support to define each of the plurality of apertures and a plurality of removable chads; and
removing the chads from the construct with a stripping pin.

18. A construct for heating, browning, and/or crisping a food item in a microwave oven, comprising:
a microwave energy interactive material supported on a polymer film;
a corrugated support joined to the microwave energy interactive material, the corrugated support including a plurality of flutes extending in a first direction; and
a plurality of apertures extending through the microwave energy interactive material, polymer film, and corrugated support,
wherein
each aperture has a length, a center width, and an end width,
the length of each aperture is from about 20 to about 70 mm,
the length of at least one of the apertures extends substantially in the first direction,
the center width of each aperture is from about 5 to about 20 mm in width, and
the end width of each aperture is from about 2 to about 8 mm.

19. The construct of claim 18, wherein at least one aperture has a length of from about 45 to about 65 mm, at least one aperture has a length of from about 30 to about 55 mm, and at least one aperture has a length of from about 20 to about 40 mm.

20. A method of making the construct of claim 18, comprising:
cutting the microwave energy interactive material, polymer film, and corrugated support to define each of the plurality of apertures and a plurality of removable chads; and
removing the chads with a plurality of stripping pins to form the construct.
